(19) United States
(12) Patent Application Publication
(10) Pub. No.: US 2025/0355703 A1
(43) Pub. Date: Nov. 20, 2025

(54) MODEL MANAGEMENT AND DEPLOYMENT SYSTEM

(71) Applicant: Apple Inc., Cupertino, CA (US)

(72) Inventors: Brycen L. WERSHING, Sunnyvale, CA (US); John DENNISON, Longmont, CO (US); Erik D. HORNBERGER, Pittsburgh, PA (US); Varinder SINGH, San Mateo, CA (US); Joseph E. MEYER, Fremont, CA (US); Bryan L. DUNCAN, Fremont, CA (US); James FARWELL, San Mateo, CA (US); Maurice Patrick SCOTT, Morgan Hill, CA (US); Alexander D. PALMER, San Jose, CA (US); Andrew S. TERRY, San Jose, CA (US); Joao Pedro LACERDA, Santa Cruz, CA (US); Vinay A. RAMASWAMY, Los Gatos, CA (US); Yingjie ZHENG, Palo Alto, CA (US); Chiraag SUMANTH, San Francisco, CA (US); Benjamin E. LEVINE, Raleigh, NC (US); Raziel ALVAREZ GUEVARA, Menlo Park, CA (US); Sundararaman HARIHARASUBRAMANIAN, San Jose, CA (US); Arjun MITTAL, Sunnyvale, CA (US); Henry G. MASON, Chicago, IL (US)

(21) Appl. No.: 19/012,777

(22) Filed: Jan. 7, 2025

Related U.S. Application Data
(60) Provisional application No. 63/648,160, filed on May 15, 2024.
(60) Provisional application No. 63/657,955, filed on Jun. 9, 2024.

(51) Int. Cl. G06F 9/48; G06F 9/54

(52) U.S. Cl. CPC G06F 9/4881; G06F 9/54; G06F 2209/541

(57) ABSTRACT

The subject technology provides for a model management and deployment system for machine learning models. A system includes a model manager configured to schedule execution of one or more machine learning models on one or more electronic devices or servers. The system also includes a model catalog configured to store information associated with the one or more machine learning models. The model manager may access the model catalog to determine scheduling priorities based on the stored information.

### CROSS-REFERENCE TO RELATED APPLICATION(S)

This application claims the benefit of U.S. Provisional Application Ser. No. 63/648,160, entitled “MODEL MANAGEMENT AND DEPLOYMENT SYSTEM,” and filed on May 15, 2024, and U.S. Provisional Application Ser. No. 63/657,955, entitled “DYNAMIC LOADING OF ADAPTERS FOR MACHINE LEARNING MODELS,” and filed on Jun. 9, 2024, the disclosures of which are expressly incorporated by reference herein in their entirety.

### TECHNICAL FIELD

The present description generally relates to model management and deployment system.

### BACKGROUND

Machine learning has seen a significant rise in popularity in recent years due to the availability of training data, and advances in more powerful and efficient computing hardware. Machine learning may utilize models that are executed to provide predictions in particular applications. Large language models are characterized by their substantial size, often comprising hundreds of millions to billions of parameters. These models require significant computational power and memory for training and inference. However, deploying large machine learning models across different environments presents challenges related to memory allocation and model performance in these environments.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment in accordance with one or more implementations.

FIG. 2 is a flow chart of an example process that may be performed for model management and deployment of machine learning models in accordance with one or more implementations.

FIG. 3 illustrates an example computing architecture for a model management and deployment system in accordance with one or more implementations.

FIG. 4 illustrates an example framework of a base model and adapters in accordance with one or more implementations.

FIG. 5 is a flow chart of an example process that may be performed for dynamic loading of adapters in accordance with one or more implementations.

FIGS. 6A and 6B illustrate an example process of dynamically loading an inference stack in accordance with one or more implementations.

FIG. 7 illustrates an example process of dynamically reloading an inference stack for a different application in accordance with one or more implementations.

FIG. 8 illustrates an example process of dynamically loading a base model with a different adapter instantiation for a different application in accordance with one or more implementations.

FIG. 9 illustrates an example process of dynamically loading an adapter using a draft model in accordance with one or more implementations.

FIG. 10 illustrates an example process of dynamically loading an adapter using a model state cache in accordance with one or more implementations.

FIG. 11 illustrates an electronic system with which one or more implementations of the subject technology may be implemented.

FIGS. 12A and 12B illustrate example processes for application programming interface calls in accordance with one or more implementations.

FIGS. 13A and 13B illustrate an example device and system facilitating application programming interface calls in accordance with one or more implementations.

FIGS. 14A and 14B illustrate an example frame exchange facilitating application programming interface calls in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Advancements in artificial intelligence (AI) have led to the deployment of end-user-interfacing systems, which are frequently updated due to changes in data or architecture. Conversational assistants leverage downstream large language models (LLMs) for various tasks, with updates driven by user interactions and data accumulation. As new tasks emerge, systems evolve to accommodate them, such as supporting translation and math queries. The decreasing cost per unit of computation facilitates training of larger models, while new architectures contribute to enhanced LLM performance, prompting ongoing updates and improvements in the field. A base LLM can be deployed to support various downstream tasks such as summarization, classification and chat assistance via a task-specific adapter module.

The subject technology addresses the challenge of executing large machine learning models on-device, which can demand substantial computational resources, including central processing unit (CPU) compute time, coprocessor utilization, and memory allocation. These large machine learning models can consume up to, for example, two gigabytes of memory within, for example, an eight-gigabyte device, specifically designated for a singular application or runtime, supporting a system service of considerable scale.

Embodiments of the subject technology provide for a model manager that can concurrently manage multiple machine learning models with various fine tunings. These models can be interchanged and executed in parallel, leveraging shared memory allocations within the system. This functionality extends beyond a single model to encompass multiple models simultaneously. For example, the model manager may support a primary LLM, a diffusion model, a larger language model tailored for code-related tasks, as well as smaller LLMs, such as dedicated to voice assistant functionalities. In one or more implementations, the model manager can allocate resources to accommodate concurrent demands of these diverse models during on-device operations. In one or more other implementations, the model manager can schedule runtimes across on-device and various server environments, maintaining a load balance between them. The model manager may achieve this through a flexible and extensive plug-in architecture, allowing adaptability to different machine learning requirements, such as managing both diffusion models and LLMs within the same management process.

The subject technology also addresses a challenge concerning cataloging, particularly in relation to the acquisition and utilization of on-device resources. A model catalog can serve as a data structure identifying various machine learning models as well as adapters used in conjunction with these machine learning models and/or model metadata associated therewith. In one or more implementations, the model catalog can organize and store information relevant to these models and/or adapters, allowing registration of machine learning models and configuration of associated policy information. In one or more other implementations, the model catalog can generate interfaces based on the information stored in the model catalog, facilitating integration with on-device and server-side models. In one or more other implementations, the model catalog can facilitate the registration and interface generation for both on-device and server-side models, enabling utilization of cataloged models and/or adapters across different systems.

Embodiments of the subject technology provide for model management and deployment of machine learning models. A system includes a model manager configured to schedule execution of one or more machine learning models on one or more electronic devices or servers. The system also includes a model catalog configured to store information associated with the one or more machine learning models. In one or more implementations, the model manager accesses the model catalog to determine scheduling priorities and/or resource requirements (e.g., processor type, amount of memory, etc.) based on the stored information.

Embodiments of the subject technology also provide for dynamic loading of adapters for machine learning models. A system includes a model catalog having information identifying one or more base models and a plurality of adapters, and a model manager configured to receive a first application programming interface (API) call indicating a request to access an inference task for performing a first task associated with a first application process. Based on the first API call, the model manager can identify a base model of the one or more base models and a first adapter of the plurality of adapters to formulate the inference task based on accessed information from the model catalog. The model manager can load the base model and the first adapter to perform the first task in response to the first API call, in which each of the plurality of adapters includes a separate set of mutable weight values tailored for different tasks.

Implementations of the subject technology improve the ability of a given electronic device to provide machine-learning generated data to a user (e.g., a user of the given electronic device). These benefits therefore are understood as improving the computing functionality of a given electronic device, such as an end user device which may generally have less computational and/or power resources available than, e.g., one or more cloud-based servers. For example, the subject system may provide for efficient utilization of processing and/or memory resources on an electronic device.

As described herein, content is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In one or more implementations, novel automatically-generated content that is generated via one or more AI processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as LLMs. Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In one or more implementations, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In one or more implementations, a random or pseudo-random seed is used as part of the prompt for creating generative content (e.g., the random or pseud-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

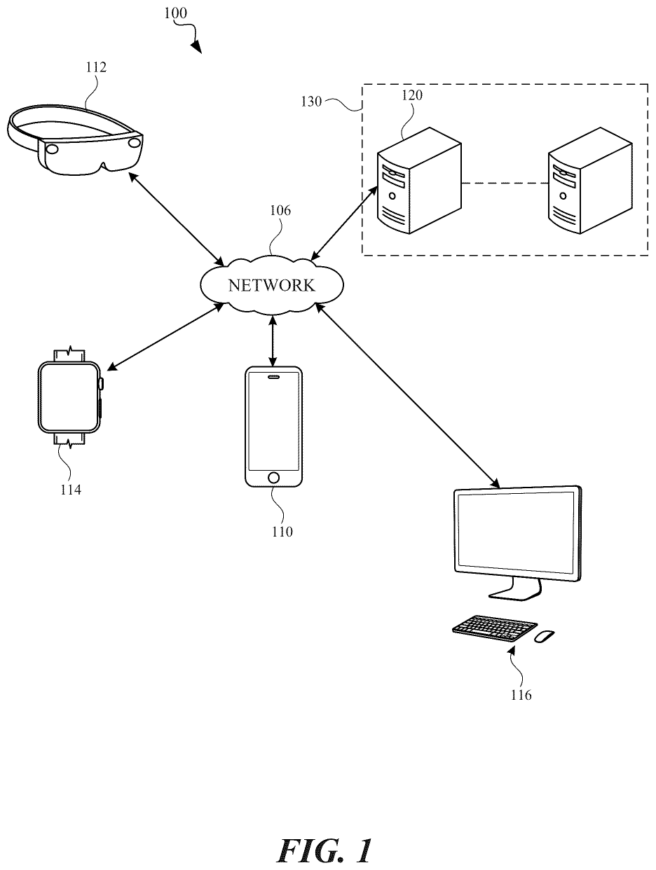

FIG. 1 illustrates an example network environment 100 in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 includes an electronic device 110, an electronic device 112, an electronic device 114, an electronic device 116, and a server 120. The network 106 may communicatively (directly or indirectly) couple the electronic device 110 and/or the server 120. In one or more implementations, the network 106 may be an interconnected network of devices that may include, or may be communicatively coupled to, the Internet. For explanatory purposes, the network environment 100 is illustrated in FIG. 1 as including the electronic device 110, the electronic device 112, the electronic device 114, the electronic device 116, and the server 120; however, the network environment 100 may include any number of electronic devices and any number of servers or a data center including multiple servers.

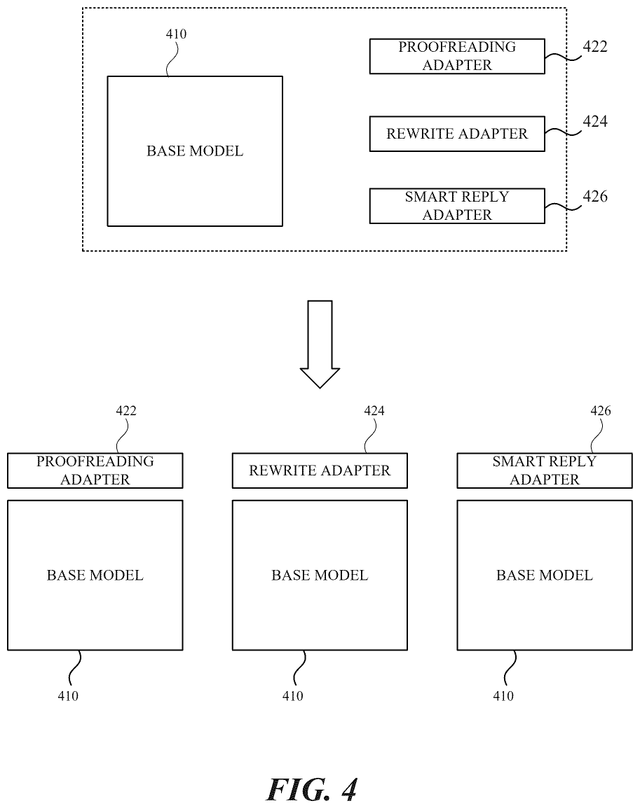

The electronic device 110 may be, for example, a desktop computer, a portable computing device such as a laptop computer, a smartphone, a peripheral device (e.g., a digital camera, headphones), a tablet device, a wearable device such as a watch, a band, and the like. In FIG. 1, by way of example, the electronic device 110 is depicted as a mobile electronic device (e.g., smartphone). The electronic device 110 may be, and/or may include all or part of, the electronic system discussed below with respect to FIG. 4.

The electronic device 112 may be, for example, desktop computer, a portable computing device such as a laptop computer, a smartphone, a peripheral device (e.g., a digital camera, headphones), a tablet device, or a wearable device such as a head mountable portable system, that includes a display system capable of presenting a visualization of an extended reality environment to a user. In FIG. 1, by way of example, the electronic device 112 is depicted as a head mountable portable system. The electronic device 112 may be, and/or may include all or part of, the electronic system discussed below with respect to FIG. 4.

The electronic device 114 may be, for example, desktop computer, a portable computing device such as a laptop computer, a smartphone, a peripheral device (e.g., a digital camera, headphones), a tablet device, a wearable device such as a watch, a band, and the like. In FIG. 1, by way of example, the electronic device 114 is depicted as a watch. The electronic device 114 may be, and/or may include all or part of, the electronic system discussed below with respect to FIG. 4.

The electronic device 116 may be, for example, desktop computer, a portable computing device such as a laptop computer, a smartphone, a peripheral device (e.g., a digital camera, headphones), a tablet device, a wearable device such as a watch, a band, and the like. In FIG. 1, by way of example, the electronic device 116 is depicted as a desktop computer. The electronic device 116 may be, and/or may include all or part of, the electronic system discussed below with respect to FIG. 4.

In the example of FIG. 1, the electronic device 110 is depicted as a smartphone. However, it is appreciated that the electronic device 110 may be implemented as another type of device, such as a wearable device (e.g., a smart watch or other wearable device). The electronic device 110 may be a device of a user (e.g., the electronic device 110 may be associated with and/or logged into a user account for the user at a server). Although a single electronic device 110 is shown in FIG. 1, it is appreciated that the network environment 100 may include more than one electronic device, including more than one electronic device of a user and/or one or more other electronic devices of one or more other users.

The server 120 may form all or part of a network of computers or a group of servers 130, such as in a cloud computing or data center implementation. For example, the server 120 stores data and software, and includes specific hardware (e.g., processors, graphics processors and other specialized or custom processors, such as neural processors) for rendering and generating content such as graphics, images, video, audio and multi-media files. In an implementation, the server 120 may function as a cloud storage server that stores any of the aforementioned content generated by the above-discussed devices and/or the server 120.

In one or more implementations, one or more of the electronic devices 110-116 may provide a system for training a machine learning model using training data, where the trained machine learning model is subsequently deployed to one or more of the electronic devices 110-116. Further, one or more of the electronic devices 110-116 may provide one or more machine learning frameworks for training machine learning models and/or developing applications using such machine learning models. In an example, such machine learning frameworks can provide various machine learning algorithms and models for different problem domains in machine learning. In an example, the electronic device 110 may include a deployed machine learning model that provides an output of data corresponding to a prediction or some other type of machine learning output. In one or more implementations, training and inference operations that involve individually identifiable information of a user of one or more of the electronic devices 110-116 may be performed entirely on the electronic devices 110-116, to prevent exposure of individually identifiable data to devices and/or systems that are not authorized by the user.

The server 120 may provide a system for training a machine learning model using training data, where the trained machine learning model is subsequently deployed to the server 120 and/or to one or more of the electronic devices 110-116. In an implementation, the server 120 may train a given machine learning model for deployment to a client electronic device (e.g., the electronic device 110, the electronic device 112, the electronic device 114, the electronic device 116). In one or more implementations, the server 120 may train portions of the machine learning model using (e.g., anonymized) training data from a population of users, and one or more of the electronic devices 110-116 may train portions of the machine learning model using individual training data from the user of the electronic devices 110-116. The machine learning model deployed on the server 120 and/or one or more of the electronic devices 110-116 can then perform one or more machine learning algorithms. In an implementation, the server 120 provides a cloud service that utilizes the trained machine learning model and/or continually learns over time.

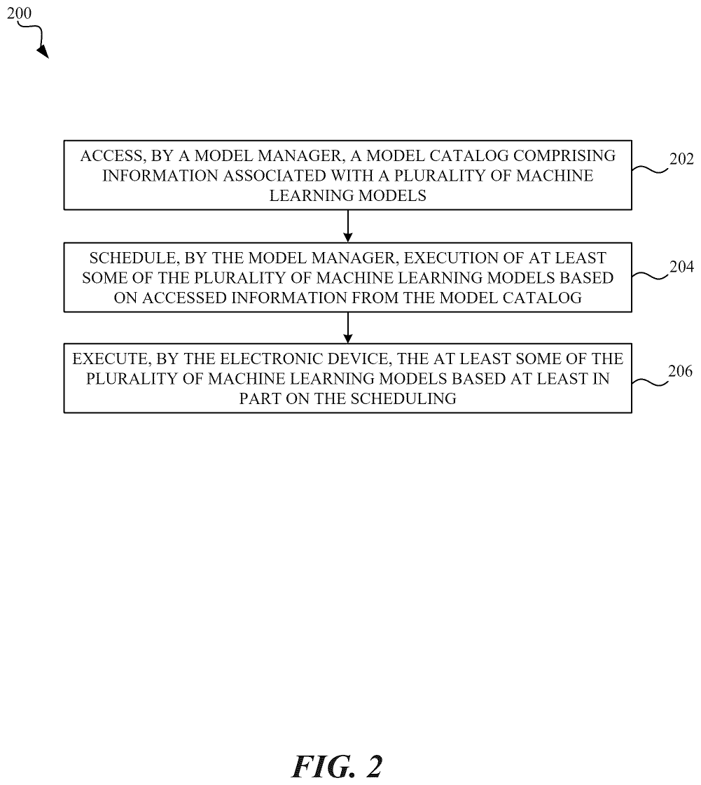

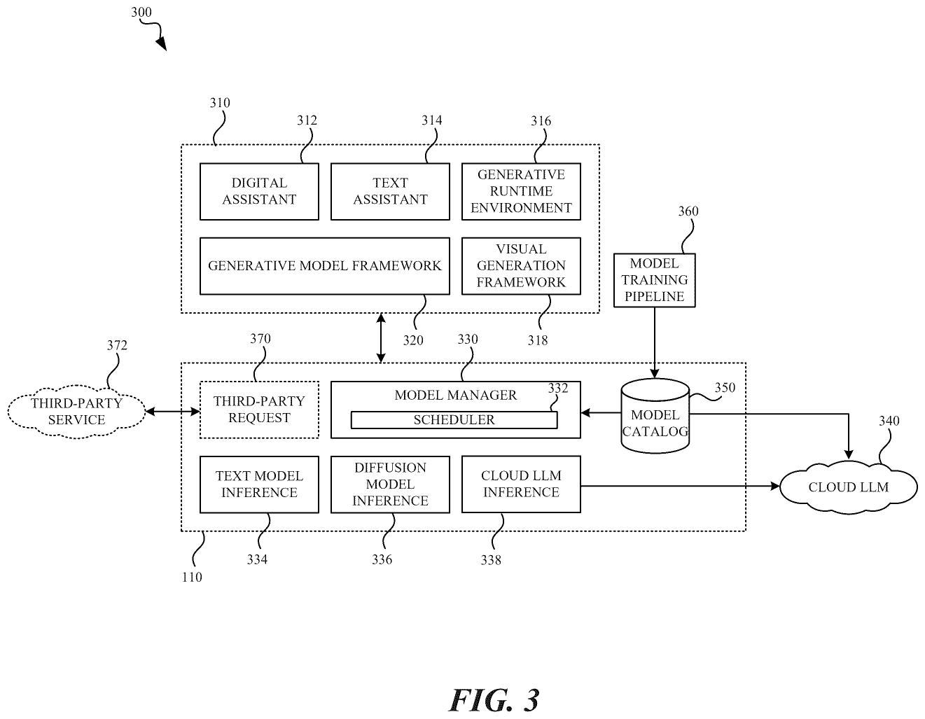

FIG. 2 is a flow chart of an example process that may be performed for model management and deployment of machine learning models in accordance with one or more implementations. For explanatory purposes, the process 200 is primarily described herein with reference to the electronic device 110 of FIG. 1. However, the process 200 is not limited to the electronic device 110 of FIG. 1, and one or more blocks (or operations) of the process 200 may be performed by one or more other components of other suitable devices and/or servers. Further for explanatory purposes, some of the blocks of the process 200 are described herein as occurring in serial, or linearly. However, multiple blocks of the process 200 may occur in parallel. In addition, the blocks of the process 200 need not be performed in the order shown and/or one or more blocks of the process 200 need not be performed and/or can be replaced by other operations. For purposes of brevity in explanation, aspects of the process 200 will be discussed with reference to FIG. 3.

FIG. 3 illustrates an example computing architecture 300 for a model management and deployment system in accordance with one or more implementations. As illustrated in FIG. 3, the electronic device 110 includes a model manager 330 and a model catalog 350. The model catalog 350 is accessible to cloud LLM 340. In one or more implementations, the model manager 330 functions as a scheduling process responsible for managing the execution of machine learning model inferences. For example, these inferences may include text model inference 334, diffusion model inference 336, cloud LLM inference 338, among others. The cloud LLM inference 338 is also accessible to the cloud LLM 340.

Various clients 310 may be executed by (or run on) the electronic device 110, including a digital assistant 312, a text assistant 314, and a generative runtime environment 316, which can interact with the model manager 330 to request inferences (e.g., text model inference 334, diffusion model inference 336, cloud LLM inference 338). These clients can take the form of applications, such as the generative runtime environment 316, or system services such as the digital assistant 312. These clients may represent higher-level user experiences that utilize the model manager 330 scheduling system to initiate and manage inference tasks.

The generative model framework 320 and visual generation framework 318 can serve as client frameworks utilized to abstract interactions with the daemon process. In one or more implementations, the generative model framework 320 and visual generation framework 318 may declare different assets with which they interact. For example, the generative model framework 320 may interact with text-based features, while the visual generation framework 318 may interact with image diffusion-based features sourced from the model catalog 350.

In one or more implementations, when an application engages in a generative experience, the application can initiate a session to manage its operations. For example, an application may enter a generative mode and subsequently may need to execute five instances of an LLM. In one or more implementations, a generative experience may involve the application performing operations that produce novel outputs or content, which can include generating text, images, audio, or video. For example, a generative experience may involve a text generation application creating unique articles or stories based on a set of input keywords. Another example may include an image generation application producing original artwork or designs from specified themes or styles. During a generative experience, the application may initiate a session to handle the computational processes, resource allocation, and data management needed to produce the new content.

Upon initiating this generative mode, the application may send a pre-warm request to the model manager 330 through an application programming interface (API) to prepare or initialize the required LLM executions before the session begins. The model manager 330 may be configured to handle different sessions concurrently, each session with its own set of model bundles and assets. These assets may consist of a base model, shared across various LLM use cases, and adapter components tailored to specific tasks. For example, a generative experience may utilize a bundle that includes a base model and a corresponding adapter. Furthermore, background sessions may share the same base model but employ different adapters depending on the task requirements. The model manager 330 maintains awareness of these diverse sessions and may dynamically adjust resource allocation based on system conditions, facilitating optimal performance.

In one or more implementations, the model catalog 350 resides on the electronic device 110, managed by the model manager 330, which can operate as a daemon process. The model catalog 350 may function as a daemon process on the electronic device 110. Within this framework, the text model inference 334, diffusion model inference 336, and cloud LLM inference 338 may be configured as plugin subprocesses. These subprocesses can be terminated independently using memory allocation mechanisms if excessive memory usage is detected.

The cloud LLM 340 may be associated with the cloud LLM inference 338. In one or more implementations, the cloud LLM inference 338 may run multiple instances for different LLMs, even if these instances are the same as the on-device LLM. In one or more other implementations, the cloud LLM 340 can run multiple server providers, accessing different server environments.

In one or more other implementations, third-party request module 370 may involve a process where a request for the text assistant 314 may be handled. The request may be redirected to a third-party service 372, which then generates a response that is fed back to the client. The APIs used by the client are consistent across different models, whether they are on-device models, third-party models, or cloud-based LLMs (e.g., cloud LLM 340). For third-party requests, specific third-party API implementations may be facilitated to interact with the third-party service 372. The third-party request module 370 may facilitate the interaction with the third-party service 372, translate requests into third-party API requests, obtain an API response, and deliver the API response back to the client.

As illustrated in FIG. 3, the model catalog 350 accesses a model training pipeline 360 that includes training data (not shown) for training a machine learning (ML) model, which may be stored in or accessible via the model catalog 350. In an example, the model training pipeline 360 may utilize one or more machine learning algorithms that uses the training data for training a ML model. The ML model may include one or more neural networks. In one or more implementations, the ML model is an LLM.

Referring back to FIG. 2, at block 202, an apparatus (e.g., model manager 330; processing unit(s) 412) running on a device (e.g., electronic device 110, 112, 114, 116) can access a model catalog (e.g., model catalog 350 of FIG. 3) that includes information associated with multiple machine learning models. In one or more implementations, the model catalog 350 serves as a repository of information for various applications, detailing the specific models and their associated base model and data components. The model catalog 350 may function akin to assembling modular blocks, determining the necessary components for each application. In one or more other implementations, the model catalog 350 includes estimations of memory characteristics for loading specific models and adapters, providing information associated with the cataloged machine learning models for the scheduling process performed by the model manager 330. In one or more other implementations, the model catalog 350 can store characteristics of the machine learning models once they are loaded, facilitating management and allocation of resources.

In one or more implementations, one or more adapters stored in the model catalog 350 may be tailored for applicability with specific models. For example, an adapter may serve as an interface that allows specific models to interact with a broader system. An adapter may facilitate the integration of these models into the broader system by facilitating the translation of data and functionality between the models and system architecture. In one or more other implementations, one or more adapters stored in the model catalog 350 may be applicable to all models. In one or more implementations, each adapter in the model catalog 350 may be compatible with one base model as specified in the model catalog 350. In this regard, there may be a relationship between adapters and base models. For example, the model manager 330 may allow for up to two adapters to be stacked on one base model simultaneously. In one or more other implementations, a different number of adapters may be stacked on one base model. The number of adapters that can be stacked on the base model may depend on memory constraints, with the model manager 330 configured to facilitate efficient memory usage and model deployment. In one or more implementations, the base model may be implemented as a larger machine learning model such as a three billion parameter LLM, for example, whereas an adapter may be implemented as a smaller model such as an 85 million parameter model, for example.

In one or more implementations, the memory characteristics as specified in the model catalog 350 may be initially provided in advance, while the actual requirements of the model request are dynamically determined. In one or more other implementations, both the memory characteristics and the model request details can be provided either dynamically or statically.

In one or more implementations, the model manager 330 considers the potential memory impact for inference operations. In one or more other implementations, the model manager 330 may consider other factors including the delivery and versioning of machine learning models within the system, as well as how clients specify which models, they intend to use for particular use cases. The model catalog 350 can function as a registry, storing metadata such as model names, their associated use cases, and the anticipated memory characteristics. The clients 310 can then declare their model and adapter preferences when initiating model queries.

In one or more implementations, the machine learning models can originate from either internal development (e.g., on the electronic device 110) or third-party sources. These models can be trained using proprietary or third-party datasets and are then cataloged by the model catalog 350. Once developed, some models may be packaged into the operating system (OS), while other models may be delivered as separate mobile assets, which can be updated over-the-air (OTA) using transport layer security (TLS).

In one or more implementations, the model catalog 350 may be integrated into the OS of the electronic device 110 and exposed through an API to developers, providing them with available model choices and relevant details. The model catalog 350 may be configured for OTA updates, allowing for the addition or modification of models and catalog information independent of the OS. The model catalog 350 may be accessed via the API to determine the available models, their functionalities, and memory constraints. As such, this information can be used to select the appropriate model for the requesting application, communicating its selection by way of a model request to the scheduler 332. OTA updates to the model catalog 350 facilitates access to new models and adjustments to API calls, using identifiers to specify the desired model for inference tasks handled by the scheduler 332.

In one or more implementations, different API calls may not be used depending on whether the model being run is a diffusion model or an LLM model. The API call can remain consistent between different model selections. In one or more other implementations, the routing of these API calls may vary based on the capabilities supported by each model.

Although the frameworks (e.g., generative model framework 320, visual generation framework 318) have distinct functionalities, these frameworks may issue similar API calls to the scheduler 332 with different parameters. In one or more other implementations, specialized scheduler functions may be implemented depending on which framework is invoking the scheduler 332. In one or more implementations, the scheduler 332 may be configured as a general-purpose schedule such that it is not configured specifically for LLM or diffusion models. For example, the diffusion backend and frontend may handle diffusion models differently than the LLM frontend and backend. In one or more implementations, these models (e.g., diffusion models, LLMs) can exhibit distinct properties and have different tunable settings in the model catalog 350.

In one or more implementations, an on-device application may utilize a specific identifier to indicate which model is selected for a particular inference task. The model catalog 350 may provide detailed instructions on how to execute the inference, including identifying information for the model and processor type for the model. In one or more other implementations, the model catalog 350 can specify which backends are compatible with the model and provide information on various tunable parameters, such as scheduler features and associated costs. In one or more implementations, the model manager 330 can support multiple models for both on-device and on-server environments, allowing for flexible deployment configurations. In one or more other implementations, the model manager 330 can prioritize model preferences, accommodating factors such as model size on-device or server destination preference.

In one or more other implementations, the model manager 330 may utilize a dynamic mode, which operates between loaded and unloaded states, providing memory-saving benefits and reduced latency for supported models. The model manager 330 may utilize this mode to determine when to engage, optimizing memory usage and performance. In one or more other implementations, the model manager 330 may implement tuning policies, such as a cacheable bit, based on settings in the model catalog 350.

In one or more other implementations, the model manager 330 may facilitate selection of models to run by determining a current hardware framework of the electronic device 110. For example, if a device has a larger memory footprint, the device can accommodate more models concurrently. In addition, the model manager 330 may factor in the amount of processing resources available on one or more CPUs, GPUs, or specialized processors of the electronic device 110, such as based on current processor loads. The number of models supported by the electronic device 110 may be based on the minimum configuration deemed feasible for the hardware implemented in the electronic device 110. As technology advances and hardware becomes more powerful, the model manager 330 may be configured to adjust policies regarding model selection and memory usage accordingly. In one or more implementations, the model manager 330 may be configured to deploy models that require higher memory capacities, which may be cataloged in the model catalog 350.

In one or more implementations, the model manager 330 may address the technical problem of scheduling runtimes for multiple machine learning models. Referring back to FIG. 2, at block 204, the model manager 330 can schedule execution of at least some of the plurality of machine learning models based on the accessed information from the model catalog 350. In one or more implementations, the model manager 330 may be executed as a daemon process, with sub-processes dedicated to inference tasks. In one or more implementations, the model manager 330 may leverage other systems to better manage memory resources, particularly in scenarios with high contention.

The model manager 330 can operate within a plugin architecture, where each backend, including on-device fusion, on-device LLMs, and/or various cloud LLM 340 services, provides its own plugin. In one or more implementations, requests can be routed to a plugin based on specified criteria, such as whether the request supports local or cloud LLM 340 services. The model manager 330 can also operate on sessions, where different processes may have open sessions during user interactions. In one or more implementations, requests for model runs can be made within these sessions, allowing for efficient management of resources and scheduling of runtimes.

In one or more implementations, the model manager 330 may interface with various system states to determine resource allocation strategies. In one or more implementations, the model manager 330 may employ a state machine for each session, enabling preemptive loading or unloading of resources based on the session's state. For example, resources may be unloaded when not in use, such as during camera launches, to reclaim memory. By integrating the model manager 330 with memory allocation mechanisms, the model manager 330 may be configured to free up additional resources as needed.

In one or more implementations, the model manager 330 may include a scheduler 332 that further facilitates the allocation of resources by processing pending requests, scheduling runtimes of models and adapters, and running foreground tasks as prioritized. The model manager 330 may employ optimization strategies to minimize context switching costs between different adapters during the scheduling of runtimes for machine learning models. In one or more implementations, the scheduler 332 prioritizes requests to reduce the number of context switches required, favoring consecutive runs of the same adapter before switching to another adapter.

In one or more implementations, the scheduler 332 may operate entirely on an application processor running on the electronic device 110, without involvement from any ancillary processors. In one or more other implementations, all components of the scheduler 332 may run on the main host processor of the electronic device 110. In one or more other implementations, the scheduler 332 may be managed by a daemon process responsible for its execution.

In one or more other implementations, the model manager 330 may employ a concept of coexistence in its scheduling process. For example, the scheduler 332 may dynamically adjust scheduling decisions based on the overall activity within the OS running on the electronic device 110. In one or more other implementations, the model manager 330 may employ assertion-based mechanisms to optimize resource utilization, such as clearing caches and avoiding unnecessary inference during resource-intensive operations such as camera usage or gaming. In one or more other implementations, the scheduler 332 may differentiate between foreground and background tasks, assigning higher priority to user-initiated actions over background processes. For example, the model manager 330 may pause or cancel background tasks to prioritize user-initiated activities. These optimization strategies taken by the model manager 330 aim to enhance efficiency in managing multiple models on-device.

In one or more other implementations, the model manager 330 employs a budget mechanism to manage the allocation of resources for running machine learning models on-device. The budget mechanism may allow for the deployment of either two adapters concurrently with a base model or a combination of one adapter and one small model alongside the base model. The budget mechanism may consider factors such as memory utilization for an adaptive memory agent (AMA) running on the electronic device 110. In one or more implementations, the budget mechanism may dynamically adjust the budget allocation for models, allowing for adjustments based on resource availability.

In one or more other implementations, the scheduler 332 may utilize certain memory allocation mechanisms that enables the scheduler 332 to identify and terminate individual processes exceeding specific memory thresholds. By executing these providers in separate processes, the model manager 330 can prioritize and terminate misbehaving processes systematically. This approach allows the model manager 330 to perform more efficient memory reclamation compared to relying solely on operating system mechanisms.

In one or more other implementations, the scheduler 332 may partition tasks into subprocesses to manage memory usage more efficiently. For example, on a tablet where a user engages in a generative experience alongside another application such as a social media application in split-screen mode, memory demands may exceed the tablet's memory capacity. In such cases, if the memory usage of the social media application surges, the scheduler 332 can reclaim memory from one of the subprocesses dedicated to the generative experience. This process may occur in the background, allowing the user to continue their activities without interruption.

In one or more other implementations, the scheduler 332 may distinguish between on- device and on-server processes. For example, the scheduler 332 may prioritize server processes, granting them immediate access. In this regard, the model manager 330 may accommodate variations in parameters between on-device and on-server deployments of models.

In one or more implementations, the model manager 330 may employ a queue, where model requests in the queue may be dropped due to various memory constraints or limitations. In one or more other implementations, the model manager 330 may not service all model requests within specified timeframes, leading to the necessity of dropping certain model requests. Upon dropping a request, the requesting application is notified, and it may choose to resubmit the model request. This resubmission process may involve on-device camera operations, where clients may need to retry their requests at different intervals.

In one or more implementations, model requests may be assigned with priority indicators when making API calls to the scheduler 332. These priority indicators may be implemented using quality-of-service (QoS) mechanisms, which allow for differentiation between requests based on their urgency or importance. In one or more implementations, the scheduler 332 may adhere to the priority indicators, organizing the model requests into a queue and scheduling runtimes accordingly. In one or more other implementations, the scheduler 332 may consider the visibility of the process associated with each request to determine its scheduling priority.

Referring back to FIG. 2, at block 206, the device can execute, by the electronic device 110, the at least some of the plurality of machine learning models based at least in part on the scheduling. In one or more implementations, the model manager 330 may be configured to set the number of machine learning models running on-device, aiming to minimize the impact on the overall operating system. For example, the model manager 330 may set the number to two small models and one large model to run on the electronic device 110. The model manager 330 may monitor that the memory budget constraint is not exceeded (e.g., the electronic device 110 may be equipped with limited on-device memory).

FIG. 4 illustrates an example framework of a base model and adapters in accordance with one or more implementations. In one or more implementations, dynamic loading of adapters is performed. Adapters can refer to specific programs, which can be small AI programs that the model manager 330 (FIG. 3) attempts to load and execute. For example, a proofreading program can include a base model 410 implemented as an LLM and a proofreading adapter 422 loaded on top of the base model 410. In one or more implementations, the proofreading adapter 422 can modify the output of the base model 410 by enhancing its grammar, structure, and overall readability. Similarly, a rewrite program can include the base model 410 and a rewrite adapter 424 loaded onto the base model 410. In one or more implementations, the rewrite adapter 424 can modify the output of the base model 410 by altering responses of the base model 410 to adhere to specific stylistic, grammatical, or contextual adjustments specified by the rewrite program. Similarly, a smart reply program can include the base model 410 and a smart reply adapter 426 loaded onto the base model 410. In one or more implementations, the smart reply adapter 426 can modify the output of the base model 410 by enhancing or adjusting responses of the base model 410 to better align with smart reply functionalities. These adapters can be stored in the model catalog 350 (FIG. 3), which may contain various adapters as assets for the model manager 330. When a program needs to be run, the requested adapters can be loaded and executed by the model manager 330.

In one or more implementations, the base model 410 is a neural network trained on a dataset. The base model 410 can remain constant across different adapters. In one or more implementations, the base model 410 includes a single instance to which multiple adapters can be attached. Due to the substantial size of the base model 410, the base model 410 may be loaded once between different adapters. When running various applications, each adapter may refer to the already-loaded base model 410. In one or more implementations, each adapter may possess specific dynamic mutable weight values, which are filled into mutable weights of the base model 410 upon attachment to the base model 410. In one or more implementations, mutable weights allow for dynamic patching of a new set of weight values into the base model at runtime. This can enable the loading of the base model 410 with non-mutable weight values and dynamic addition of mutable weight values during, and/or immediately prior to, inference. Different instances with varied weights can be created, serving as different adapters. For example, by plugging in a set of mutable weight values tailored for a proofreading task, the proofreading adapter 422 can be generated.

In one or more implementations, a learning framework can be established for accommodating mutable weights and loads. This learning framework may involve segregating weights of the base model 410, while adjustments to intermediate weights can be made to accommodate various adapters. In one or more implementations, during training, the base model 410 includes specific linear layers within a transformer model architecture. The weights of the base model 410 may be divided, with one portion designated for general LLM tasks, while another portion is reserved for learned weights specific to each adapter. In one or more implementations, the model manager 330 may store multiple sets of weights concurrently in memory, retaining previous sets of weights in memory. The mutable weight values can be determined during a model setup phase, in which each adapter is trained with its own set of mutable weight values tailored to its specific task. For example, each adapter may be associated with a separate training dataset distinct from the training dataset of the base model 410. The mutable weights can be trained to enhance the predictive capabilities of the adapter for a particular use case. Subsequently, these mutable weight values can be packaged into separate data files and deployed for loading onto an electronic device (e.g., the electronic devices 110-116 of FIG. 1).

In one or more implementations, multiple instances of adapters can be generated, each adapter referring to a single static instance of weights for the base model 410. The task descriptors can be loaded once the adapters introduce their custom weights based on fine-tuning. In one or more other implementations, multiple fine-tuned adapters may be loaded concurrently with a single instance of the base model 410 with all adapters sharing that same instance of the base model 410. Various instances of mutable weight values can then be incorporated into these adapters. For example, there can be distinct sets of mutable weight values for tasks such as proofreading and smart reply. Despite differences between the sets of mutable weights, the adapters can operate concurrently within a same model instance. For example, separate adapters can be executed simultaneously while relying on the same weights of the base model 410. In one or more implementations, there exists a fixed set of mutable nodes with fixed sets of mutable weights. Multiple sets of these mutable weights can be loaded and used concurrently. As such, the base model 410 may allow for the concurrent use of multiple sets of weights without needing to discard existing weights.

Each adapter may include weight values that are fine-tuned for a specific task. For example, in the task of proofreading, the training of the proofreading adapter 422 may involve fine tuning the weights specifically for proofreading. Similarly, for tasks such as generating smart replies, the smart reply adapter 426 may be fine-tuned for that particular task. When an adapter is loaded for a specific task, the weights of the base model 410 can be modified accordingly to optimize performance for that task.

In one or more implementations, context switching costs may be considered by the model manager 330 when swapping out adapters during inference tasks. Once multiple adapter instances are loaded with the base model 410, each with different adapter weight values, there may be no additional overhead in switching between them for inference requests. In one or more other implementations, during the middle of an inference task, swapping out adapters may cause some interruption. In one or more implementations, two distinct channels may be established with the model manager 330. For example, one channel may be associated with the driver and the other channel may be associated with accepting requests from both adapters concurrently. In one or more other implementations, during hardware execution, the hardware may have the capability to switch between the two channels based on a priority. For example, if one channel, such as the proofreading adapter 422, operates at a lower priority while the smart reply adapter 426 operates at a higher priority, the latter channel can preempt the former channel. The switching between channels may occur based on priority once determined. In one or more other implementations, from a software standpoint, both adapters can operate simultaneously.

In one or more implementations, various hardware components may be allocated as part of the adapters. One such component may be a cache buffer. Another component may be an intermediate buffer, which may be valid only during the course of inference. In one or more implementations, the cache buffer may persist throughout an LLM inference. For example, each adapter is associated with a respective cache buffer, which preserves a state pertaining to that adapter. When multiple adapters are running concurrently and there is a switch between them, the current context for each respective adapter may be stored in the cache buffer for each respective adapter. The hardware can store certain states valid for the duration of an inference, consisting of multiple inferences. Between these inferences, the state can be preserved by a separate cache buffer. This cache buffer may be loaded when transitioning between adapters. In one or more implementations, the text model inference 334 may maintain the cache buffer, which can be bootstrapped with a previously maintained cache when engaging with any application. As there may be one instance of the base model 410, multiple applications may be connected to the cache buffer. Each time a switch occurs, the state may start fresh again.

In one or more other implementations, a signature match mechanism facilitates compatibility between the base model 410 and adapters. For compatibility, signatures should align; otherwise, the components are incompatible. During deployment, signatures can be generated for both the base model 410 and the adapter. These signatures can confirm that the adapters have been trained on the corresponding base model 410. Without this alignment, the output would be invalid. The signature match mechanism may involve producing a signature, integrating it into the base model 410, and adding it to the adapters while updating the model catalog 350. During runtime, the model manager 330 verifies that the signatures match before finalizing the integration.

In one or more implementations, the model manager 330 may apply different policies for various assets. For example, the base model 410 requires more resources for loading and unloading compared to the smaller adapters. With this granularity, model manager 330 can establish policies such as caching the base model 410 in memory for a predetermined duration of time (e.g., about 15 minutes) of inactivity before unloading it, while being more inclined to unload adapters when not in use due to their smaller size. In one or more implementations, an adapter state may be preserved upon each instantiation of a new adapter, constituting a new memory allocation. For example, each instantiation of a new adapter can result in new memory allocated to that specific adapter. As more adapters are loaded and memory resources become depleted, policies within the model manager 330 system dictate the removal (or unloading) of outdated adapters.

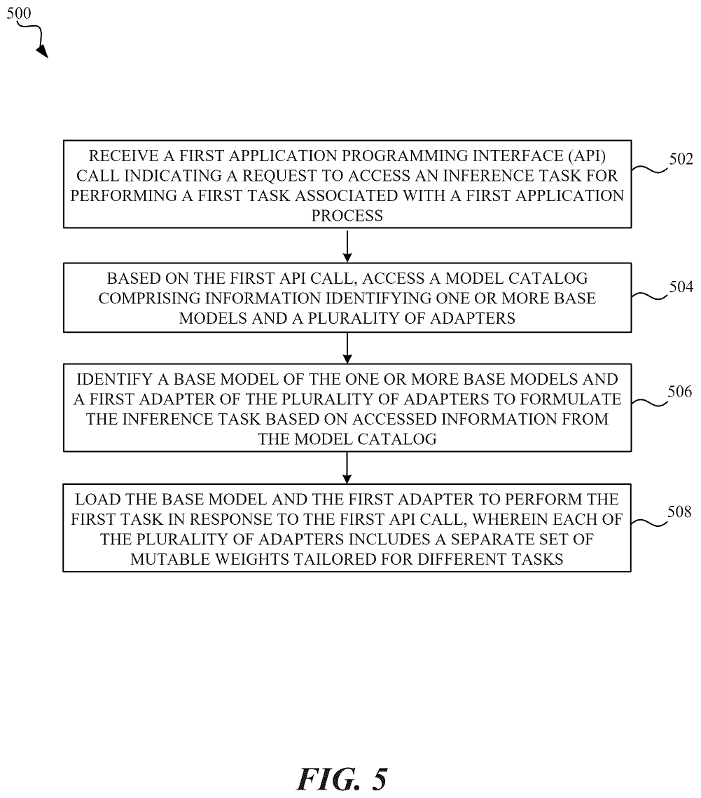

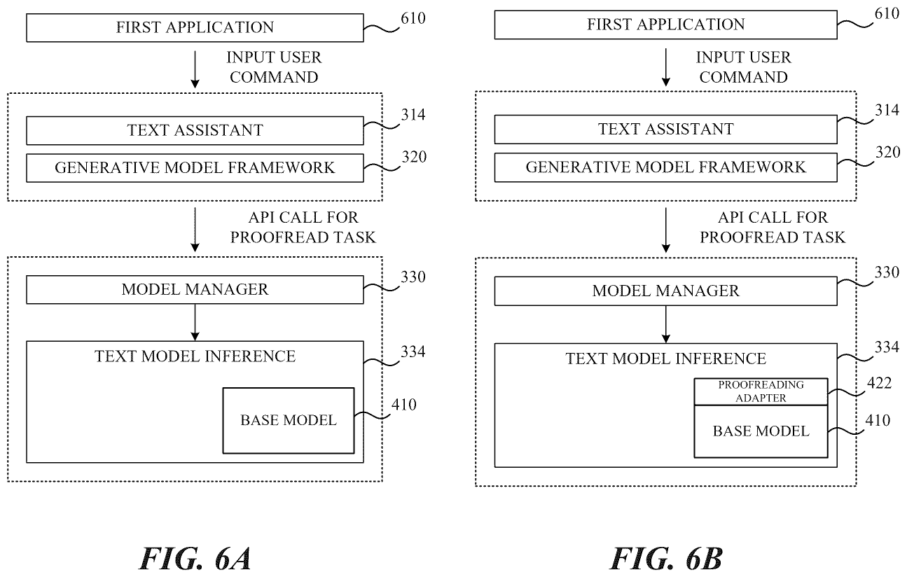

FIG. 5 is a flow chart of an example process that may be performed for dynamic loading of adapters in accordance with one or more implementations. For explanatory purposes, the process 500 is primarily described herein with reference to the electronic device 110 of FIG. 1. However, the process 500 is not limited to the electronic device 110 of FIG. 1, and one or more blocks (or operations) of the process 500 may be performed by one or more other components of other suitable devices and/or servers. Further for explanatory purposes, some of the blocks of the process 500 are described herein as occurring in serial, or linearly. However, multiple blocks of the process 500 may occur in parallel. In addition, the blocks of the process 500 need not be performed in the order shown and/or one or more blocks of the process 500 need not be performed and/or can be replaced by other operations. For purposes of brevity in explanation, aspects of the process 500 will be discussed with reference to FIGS. 6A and 6B.

FIGS. 6A and 6B illustrate an example process of dynamically loading an inference stack in accordance with one or more implementations. In one or more implementations, an AI operating system processes user interactions, including those from different users. The model manager 330 may handle inputs such as typing and proofreading tasks. The same set of standards may be applied consistently between tasks, with the base model 410 already loaded with the associated program. This can reduce the need for reloading the base model 410 and/or an adapter (e.g., the proofreading adapter 422, rewrite adapter 424, smart reply adapter 426, among others). The model manager 330 can process a given text through the base model 410 dynamically loaded with one of the adapters, and subsequently produces an output.

Referring back to FIG. 5, at block 502, an apparatus (e.g., the model manager 330; processing unit(s) 412) running on a device (e.g., electronic device 110, 112, 114, 116) can receive a first API call indicating a request to access an inference task for performing a first task (e.g., proofreading task) associated with a first application process. In one or more implementations, one or more applications running on a device (e.g., one of any electronic devices 110-116) may initiate requests for specific resources. As illustrated in FIG. 6A, the model manager 330 can process an input command such as “Select All” followed by another input command such as “Proofread This” at a first application 610 such as a text annotation application. The text to be proofread is sent to a text management system stack, which calls a text assistant software stack (e.g., stack containing the text assistant 314 and the generative model framework 320), which, in turn, invokes a model inference system (e.g., the text model inference 334) by way of an API call to carry out the proofreading task.

Referring back to FIG. 5, at block 504, the model manager 330 can access the model catalog 350 that includes information identifying one or more base models and a plurality of adapters based on the first API call. For each task, the model catalog 350 may be queried by the model manager 330 to obtain a path (e.g., uniform resource locator (URL)) to both the base model 410 and one or more adapters. In one or more implementations, the base model 410 is pre-existing and certain portions of the base model 410 are replayed upon loading an adapter with a task-specific set of weights. Each adapter may be represented by a weights file stored on the model catalog 350, while the base model 410 is represented by a serialized neural network that is also stored on the model catalog 350.

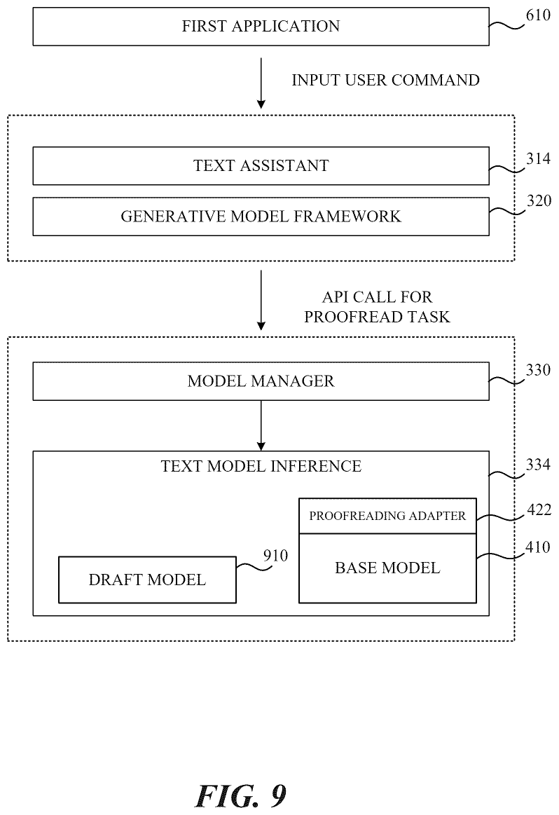

Referring back to FIG. 5, at block 506, the model manager 330 can identify a base model of the one or more base models and a first adapter of the plurality of adapters to formulate the inference task based on accessed information from the model catalog 350. In one or more implementations, the model manager 330 can access the model catalog 350 to determine how to load the requested inference stack. Initially, the model manager 330 may identify the base model 410 in the model catalog 350 and issues an instruction to load the base model 410. In one or more implementations, the model manager 330 may determine the required resources to fulfill the request. For example, a proofread request may necessitate the utilization of a large 3 billion parameter LLM (e.g., the base model 410) along with a proofread adapter (e.g., the proofreading adapter 422), and potentially a draft model for speculative decoding (as described with reference to a draft model 910 of FIG. 9). The model manager 330 may employ one or more policies to optimize resource allocation, considering factors such as existing system workload and shared resources among different requests.

Referring back to FIG. 5, at block 508, the model manager 330 can load the base model 410 and the first adapter to perform the first task in response to the first API call. The model manager 330 may then communicate with an inference to perform this task. For example, upon evaluation, the model manager 330 may dispatch these requests to an inference stack (e.g., text model inference 334) utilizing a token generation inference framework for LLM inference. Adapters may be attached to the base model 410 as directed, and the resulting inference may be returned as a response to the respective use case. In one or more implementations, the model manager 330 can load models from a bundle, facilitating requests of the application. For example, when new mail is received at the electronic device, the model manager 330 may prompt the loading of a specific set of adapters. To load the base model 410, the path of the serialized neural network (e.g., the base model 410) is passed to the electronic device. To load an adapter, the path of the corresponding adapter weights file also may be passed to the electronic device. Once the base model 410 is loaded, an adapter component is dynamically added on top of the base model 410. Subsequently, the given text is passed to the model for processing, and the output is generated.

In one or more implementations, the model manager 330 and/or the text model inference 334 may use certain criteria to ascertain the suitability of the existing inference stack for subsequent runs and to fulfill requests of a running application. For example, the model manager 330 may discern whether existing resources can be reused, particularly in the context of relying on the same adapter for subsequent tasks. A second application 710 such as a mail application may be running on the electronic device and may issue a request to run a proofreading program. In this regard, the mail application may rely on the same inference stack as described with reference to the proofreading task in FIGS. 6A and 6B. In one or more other implementations, the text model inference 334 may determine that the base model 410 is already loaded and loads the smart reply adapter 426 by running an instantiation of the smart reply adapter 426. In one or more implementations, the base model 410 and the proofreading adapter 422 are pre-loaded for a proofreading task.

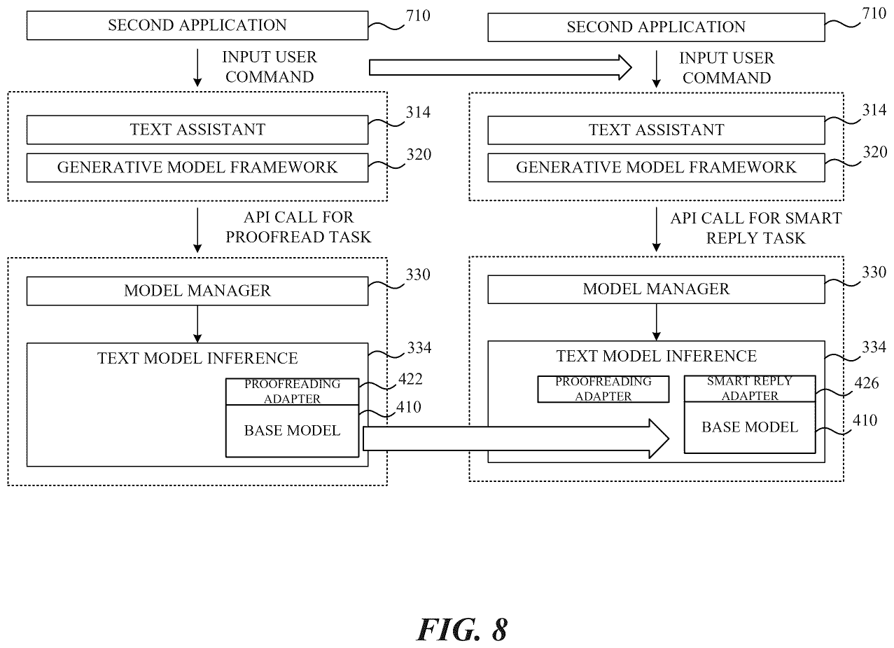

In one or more implementations, a system may include multiple applications running concurrently with each application loading all necessary resources independently. In one or more other implementations, the model manager 330 can learn the context of various applications utilizing system resources. For example, the model manager 330 may be trained with a comprehensive system-level understanding, enabling it to recognize if a particular application process requires specific resources. As illustrated in FIGS. 6A and 6B, if the first application 610 necessitates the proofreading adapter 422, the model manager 330 loads both the proofreading adapter 422 and the base model 410. Subsequently, as illustrated in FIG. 8, when the same application process (e.g., the second application 710) necessitates the smart reply adapter 426, the model manager 330 acknowledges the existing application process (e.g., the second application 710) and loads only the smart reply adapter 426, as the base model 410 is already loaded.

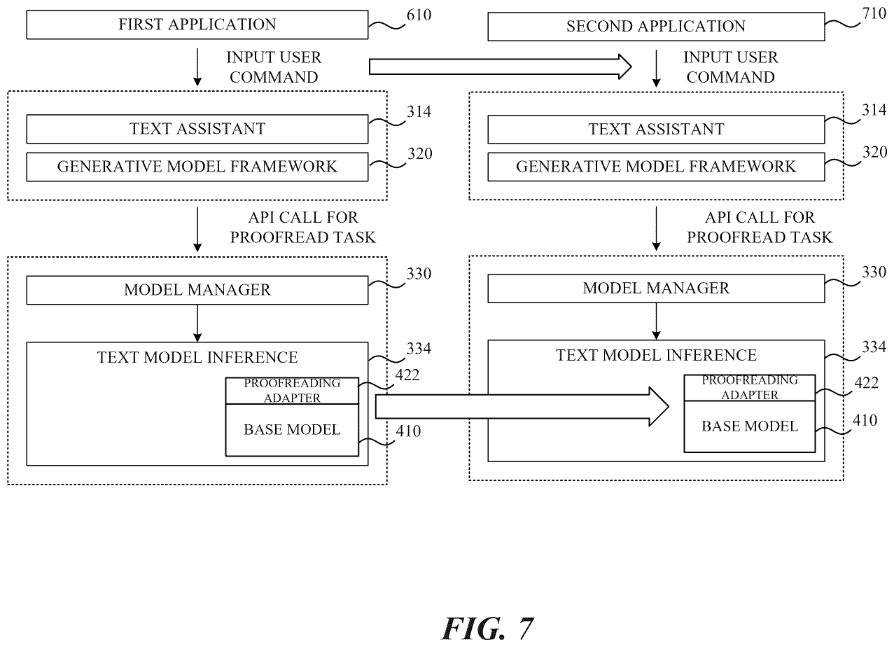

FIG. 7 illustrates an example process of dynamically reloading an inference stack for a different application in accordance with one or more implementations. In one or more implementations, the second application 710 requests a proofreading task. In this regard, between the first application 610 and the second application 710, the proofreading task involves the same base and adapter stack. The model manager 330 may determine that resources for the proofreading task is already loaded, and the proofreading task can be processed with the already-loaded resource. In one or more implementations, the second application 710 may include an identifier for the proofreading task that is consistent between the first application 610 and the second application 710. In one or more implementations, the API call for the proofreading task may include the identifier. Because this identifier can identify the same base and adapter stack for the proofreading task, no additional operation may be performed by the model manager 330, and the text model inference 334 may proceed directly with utilizing the same base and adapter stack.

FIG. 8 illustrates an example process of dynamically loading a base model with a different adapter instantiation for a different application in accordance with one or more implementations. The second application 710 (e.g., the mail application) can request the generation of a smart reply. In one or more implementations, when a user launches the second application 710 (e.g., mail application process) and initiates a message, an API call can be made. In one or more implementations, the second application 710 generates another identifier for the smart reply task. In response to the API call, the text model inference 334 engine accesses the model catalog 350 and determines the components needed for the operation using the identifier generated by the second application 710 for the smart reply task. For example, the model manager 330 determines that the text model inference 334 should utilize both the base model 410 and the smart reply adapter 426. As illustrated in FIG. 8, the model manager 330 may determine that the base model 410 is already loaded. If the base model 410 is already loaded, the model manager 330 may unload the proofreading adapter 422 and load the smart reply adapter 426 dynamically. In one or more implementations, the model manager 330 may execute the instantiation of the smart reply adapter 426 in lieu of the proofreading adapter 422 to load the smart reply adapter 426. This process can enable the model manager 330 to stack the smart reply adapter 426 on top of the base model 410. Subsequently, the smart reply program may be executed on the base model 410 loaded with the smart reply adapter 426.

FIG. 9 illustrates an example process of dynamically loading an adapter using a draft model in accordance with one or more implementations. In one or more implementations, adapters are utilized for various tasks. These adapters may encompass a draft model 910. Running the base model 410 consumes significant time and energy. For example, the base model 410 may contain 3 billion parameters, contrasting with a smaller-scale version containing only 9 million parameters. In this regard, the draft model 910 may be employed to reduce the frequency of token generation using the base model 410. In one or more implementations, the model manager 330 may load the draft model 910 and combine it with an adapter, generating preliminary outputs. In one or more implementations, the draft model 910 performs speculative decoding by having the outputs of the draft model 910 compared to the outputs generated by the base model 410 to determine its accuracy, optimizing computational resources by selectively running the base model 410 based on performance of the draft model 910. Any discrepancies between the draft model 910 and the base model 410 may prompt revisions to the draft model 910, allowing the base model 410 to correct any errors in the outputs of the draft model 910. In one or more implementations, the corrected output from the base model 410 may serve as a new input for the draft model 910. In one or more other implementations, the base model 410 may apply a marking or weighting to the new input to inform the draft model 910 of its significance as a new baseline. For example, the new input to the draft model 910 may include positional encodings, indicating the validity of the inputs. These encodings may specify which inputs are valid and which are not, considering that the draft model 910 may operate on a specific set of input tokens or words. Tokens deemed invalid can be disregarded by the draft model 910 during this process. This iterative process facilitates accuracy of the draft model 910 before proceeding with further token generation using the draft model 910.

In one or more implementations, both the draft model 910 and the base model 410 can be executed concurrently in memory, with the base model 410 being run less frequently. The draft model 910 may generate an output containing several tokens. For example, the draft model 910 generates initial words in a sentence based on an input, followed by feeding those words back to the base model 410 to predict the next word. In one or more other implementations, the base model 410 can receive the same input simultaneously to enhance performance of the draft model 910. The tokens in the output of the draft model 910 can be compared with the token output of the base model 410. If the outputs agree, the final output can be composed based on a consensus between the draft model 910 and the base model 410. For example, after confirming the agreement between the outputs, the process can continue by feeding the agreed-upon output back into the draft model 910 to continue the sequence. In one or more other implementations, if there is a disagreement between the outputs, the base model 410 can feed back corrections to the draft model 910 to reconcile the differences. For example, a disagreement between the draft model 910 and the base model 410 can occur when one model predicts an alternative continuation of the sentence from the other model. In one or more other implementations, the process can be halted by the text model inference 334 upon reaching a disagreement in the output generated by the draft model 910, returning the generated output to the base model 410 for further refinement. This iterative exchange between the draft model 910 and the base model 410 aims to minimize the usage of the base model 410 while maximizing the utilization of the draft model 910.

In one or more implementations, the text model inference 334 may utilize a lookup-based speculative decoding method, bypassing the need to load the draft model 910. Instead, the user input may be fed directly to the base model 410 for correction, continuing iteratively until a desired output is achieved. In one or more other implementations, a combination of both the base model 410 and the draft model 910 may be employed, incorporating a tree-based graph and speculative decoding. For example, the draft model 910 may be loaded to generate various branches of potential outputs. Subsequently, these outputs may be batched together and the base model 410 may verify which output is deemed correct.

In one or more implementations, the draft model 910 may be loaded based on certain system conditions such as available memory space, current loading status, and contextual considerations. For example, the draft model 910 may be loaded using a lookup-based approach when the system has constrained memory capacities. In another example, if ample memory is available, the draft model 910 may be loaded using speculative decoding.

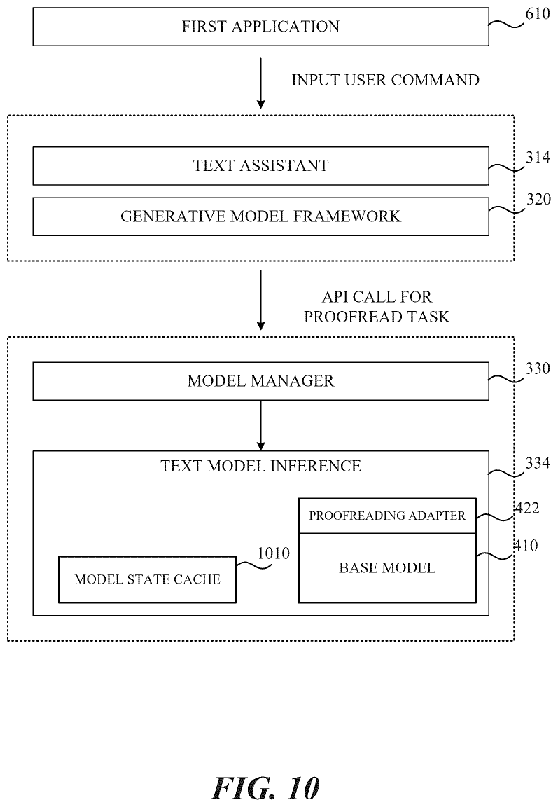

FIG. 10 illustrates an example process of dynamically loading an adapter using a model state cache in accordance with one or more implementations. In one or more implementations, the text model inference 334 may load a model state cache 1010. Upon running an adapter (e.g., the proofreading adapter 422), the model state cache 1010 can iteratively accumulate as individual tokens are fed to the model state cache 1010. Once all tokens are consumed, the model state cache 1010 can be filled. If multiple adapters are present, each adapter may have its own distinct cache set in the model state cache 1010. In instances of overlap between previous and subsequent sentences, a prefix cache may be utilized. The inference stack (e.g., proofreading adapter 422 loaded on top of the base model 410) may utilize precomputed states up to the overlapping portion before proceeding with a new input. Cache handling may remain isolated for each adapter, facilitating continuity of model state even if switching between adapters occurs mid-sentence. This may allow the base model 410 with the proofreading adapter 422 to predict based on the maintained state as long as the sentence remains relevant.

One or more implementations described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in one or more implementations, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In one or more implementations, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In one or more implementations, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In one or more implementations, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In one or more implementations, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In one or more implementations, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In one or more implementations, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In one or more implementations, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, software modules and/or components.

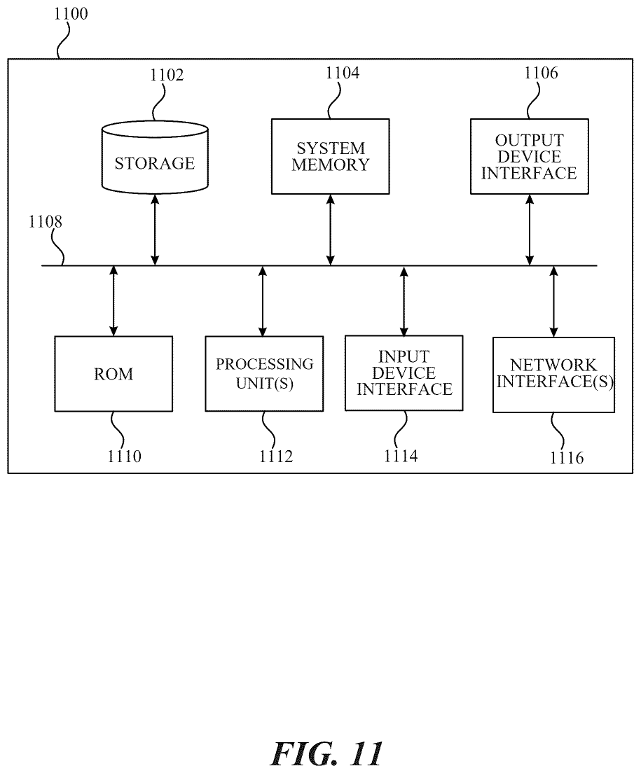

FIG. 11 illustrates an electronic system 1100 with which one or more implementations of the subject technology may be implemented. The electronic system 1100 can be, and/or can be a part of, any one of the electronic devices 110-116, and/or the server 120 shown in FIG. 1. The electronic system 1100 may include various types of computer readable media and interfaces for various other types of computer readable media. The electronic system 1100 includes a bus 1108, one or more processing unit(s) 1112, a system memory 1104 (and/or buffer), a ROM 1110, a permanent storage device 1102, an input device interface 1114, an output device interface 1106, and one or more network interfaces 1116, or subsets and variations thereof.

The bus 1108 collectively represents all system, peripheral, and chipset buses that communicatively connect the numerous internal devices of the electronic system 1100. In one or more implementations, the bus 1108 communicatively connects the one or more processing unit(s) 1112 with the ROM 1110, the system memory 1104, and the permanent storage device 1102. From these various memory units, the one or more processing unit(s) 1112 retrieves instructions to execute and data to process in order to execute the processes of the subject disclosure. The one or more processing unit(s) 1112 can be a single processor or a multi-core processor in different implementations.

The ROM 1110 stores static data and instructions that are needed by the one or more processing unit(s) 1112 and other modules of the electronic system 1100. The permanent storage device 1102, on the other hand, may be a read-and-write memory device. The permanent storage device 1102 may be a non-volatile memory unit that stores instructions and data even when the electronic system 1100 is off. In one or more implementations, a mass-storage device (such as a magnetic or optical disk and its corresponding disk drive) may be used as the permanent storage device 1102.

In one or more implementations, a removable storage device (such as a flash drive, and its corresponding solid-state drive) may be used as the permanent storage device 1102. Like the permanent storage device 1102, the system memory 1104 may be a read-and-write memory device. However, unlike the permanent storage device 1102, the system memory 1104 may be a volatile read-and-write memory, such as random-access memory. The system memory 1104 may store any of the instructions and data that one or more processing unit(s) 1112 may need at runtime. In one or more implementations, the processes of the subject disclosure are stored in the system memory 1104, the permanent storage device 1102, and/or the ROM 1110. From these various memory units, the one or more processing unit(s) 1112 retrieves instructions to execute and data to process in order to execute the processes of one or more implementations.

The bus 1108 also connects to the input device interface 1114 and output device interface 1106. The input device interface 1114 enables a user to communicate information and select commands to the electronic system 1100. Input devices that may be used with the input device interface 1114 may include, for example, alphanumeric keyboards and pointing devices (also called “cursor control devices”). The output device interface 1106 may enable, for example, the display of images generated by electronic system 1100. Output devices that may be used with the output device interface 1106 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 11, the bus 1108 also couples the electronic system 1100 to one or more networks and/or to one or more network nodes, such as the electronic device 110 shown in FIG. 1, through the one or more network interface(s) 1116. In this manner, the electronic system 1100 can be a part of a network of computers (such as a LAN, a wide area network (“WAN”), or an Intranet, or a network of networks, such as the Internet. Any or all components of the electronic system 1100 can be used in conjunction with the subject disclosure.

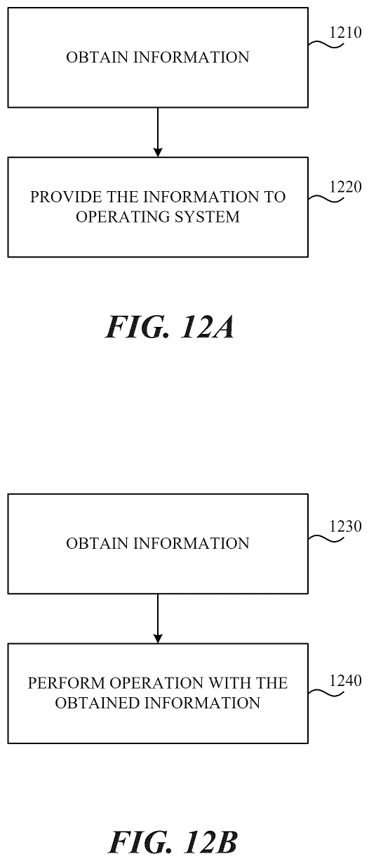

FIGS. 12A and 12B illustrate example processes for application programming interface calls in accordance with one or more implementations. Implementations within the scope of the present disclosure include a computer-readable storage medium that encodes instructions organized as an application (e.g., application 1360) that, when executed by one or more processing units, control an electronic device (e.g., device 1350) to perform the process of FIG. 12A, the process of FIG. 12B, and/or one or more other processes and/or methods described herein.

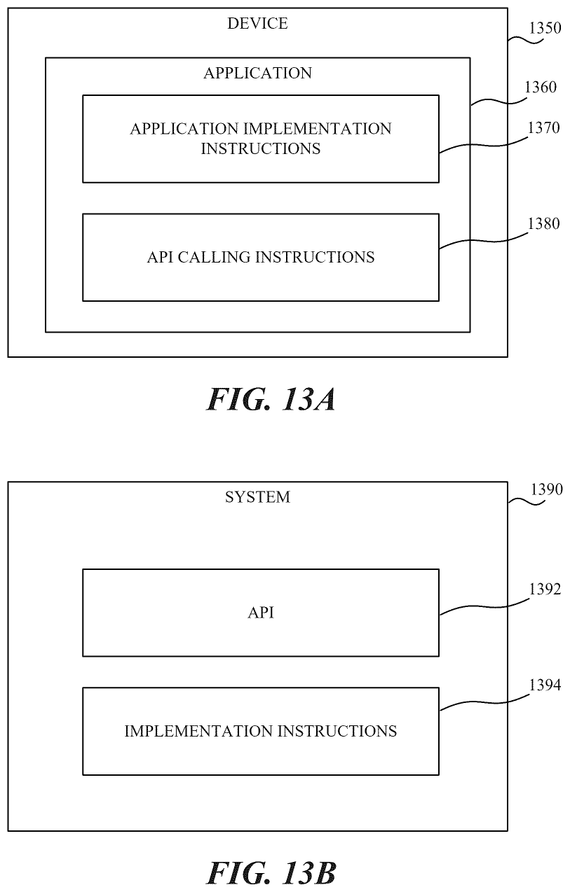

FIGS. 13A and 13B illustrate an example device and system facilitating application programming interface calls in accordance with one or more implementations. It should be recognized that application 1360 (shown in FIG. 13A) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In one or more implementations, application 1360 is an application that is pre-installed on device 1350 at purchase (e.g., a first party application). In one or more other implementations, application 1360 is an application that is provided to device 1350 via an operating system update file (e.g., a first party application or a second party application). In one or more other implementations, application 1360 is an application that is provided via an application store. In one or more implementations, the application store can be an application store that is pre-installed on device 1350 at purchase (e.g., a first party application store). In one or more other implementations, the application store is a third-party application store (e.g., an application store that is provided by another application store, downloaded via a network, and/or read from a storage device).

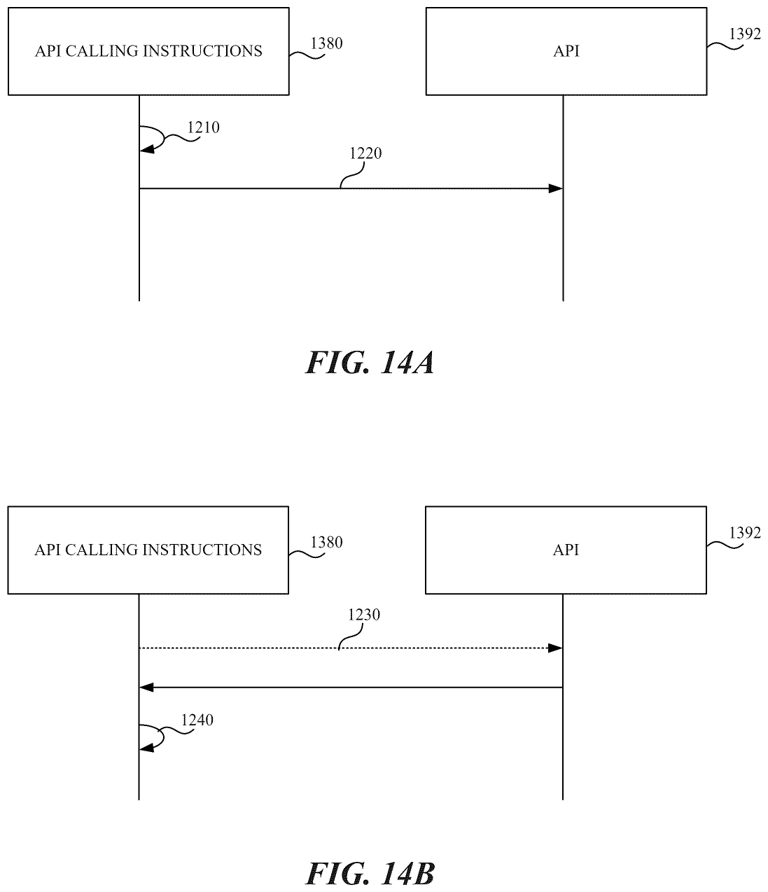

FIGS. 14A and 14B illustrate an example frame exchange facilitating application programming interface calls in accordance with one or more implementations. Referring to FIG. 12A and FIG. 14A, application 1360 obtains information (e.g., 1210). In one or more implementations, at 1210, information is obtained from at least one hardware component of the device 1350. In one or more implementations, at 1210, information is obtained from at least one software module (e.g., set of instructions) of the device 1350. In one or more implementations, at 1210, information is obtained from at least one hardware component external to the device 1350 (e.g., a peripheral device, an accessory device, a server, etc.). In one or more implementations, the information obtained at 1210 includes positional information, time information, notification information, user information, environment information, electronic device state information, weather information, media information, historical information, event information, hardware information, and/or motion information. In one or more implementations, in response to and/or after obtaining the information at 1210, application 1360 provides the information to a system (e.g., 1220).

In one or more implementations, the system (e.g., 1390 shown in FIG. 13B) is an operating system hosted on the device 1350. In one or more implementations, the system (e.g., 1390 shown in FIG. 13B) is an external device (e.g., a server, a peripheral device, an accessory, a personal computing device, etc.) that includes an operating system.

Referring to FIG. 12B and FIG. 14B, application 1360 obtains information (e.g., 1230). In one or more implementations, the information obtained at 1230 includes positional information, time information, notification information, user information, environment information electronic device state information, weather information, media information, historical information, event information, hardware information and/or motion information. In response to and/or after obtaining the information at 1230, application 1360 performs an operation with the information (e.g., 1240). In one or more implementations, the operation performed at 1240 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 1390 based on the information.

In one or more implementations, one or more steps of the process of FIG. 12A and/or the process of FIG. 12B is performed in response to a trigger. In one or more implementations, the trigger includes detection of an event, a notification received from system 1390, a user input, and/or a response to a call to an API provided by system 1390.

In one or more implementations, the instructions of application 1360, when executed, control device 1350 to perform the process of FIG. 12A and/or the process of FIG. 12B by calling an application programming interface (API) (e.g., API 1392) provided by system 1390. In one or more implementations, application 1360 performs at least a portion of the process of FIG. 12A and/or the process of FIG. 12B without calling API 1392.

In one or more implementations, one or more steps of the process of FIG. 12A and/or the process of FIG. 12B includes calling an API (e.g., API 1392) using one or more parameters defined by the API. In one or more implementations, the one or more parameters include a constant, a key, a data structure, an object, an object class, a variable, a data type, a pointer, an array, a list or a pointer to a function or method, and/or another way to reference a data or other item to be passed via the API.

Referring to FIG. 13A, device 1350 is illustrated. In one or more implementations, device 1350 is a personal computing device, a smart phone, a smart watch, a fitness tracker, a head mounted display (HMD) device, a media device, a communal device, a speaker, a television, and/or a tablet. In one or more other implementations, device 1350 is implemented as any one of electronic devices 110, 112, 114, 116. Device 1350 includes application 1360 and an operating system (not shown) (e.g., system 1390 shown in FIG. 13B). Application 1360 includes application implementation instructions 1370 and API calling instructions 1380. System 1390 includes API 1392 and implementation instructions 1394. It should be recognized that device 1350, application 1360, and/or system 1390 can include more, fewer, and/or different components than illustrated in FIG. 13A and 13B.

In one or more implementations, application implementation instructions 1370 is a software module that includes a set of one or more computer-executable instructions. In one or more implementations, the set of one or more instructions of instructions 1370 correspond to one or more operations performed by application 1360. For example, when application 1360 is a messaging application, application implementation instructions 1370 can include operations to receive and send messages. In one or more implementations, application implementation instructions 1370 communicates with API calling instructions to communicate with system 1390 via API 1392 (shown in FIG. 13B).

In one or more implementations, API-calling instructions 1380 is a software module that includes a set of one or more computer-executable instructions.

In one or more implementations, implementation instructions 1394 is a software module that includes a set of one or more computer-executable instructions.

In one or more implementations, API 1392 is a software module that includes a set of one or more computer-executable instructions. In one or more implementations, API 1392 provides an interface that allows a different set of instructions (e.g., API calling instructions 1380) to access and/or use one or more functions, methods, procedures, data structures, classes, and/or other services provided by implementation instructions 1394 of system 1390. For example, API-calling instructions 1380 can access a feature of implementation instructions 1394 through one or more API calls or invocations (e.g., embodied by a function or a method call) exposed by API 1392 and can pass data and/or control information using one or more parameters via the API calls or invocations. In one or more implementations, API 1392 allows application 1360 to use a service provided by a Software Development Kit (SDK) library. In one or more other implementations, application 1360 incorporates a call to a function or method provided by the SDK library and provided by API 1392 or uses data types or objects defined in the SDK library and provided by API 1392. In one or more implementations, API-calling instructions 1380 makes an API call via API 1392 to access and use a feature of implementation instructions 1394 that is specified by API 1392. In such embodiments, implementation instructions 1394 can return a value via API 1392 to API-calling instructions 1380 in response to the API call. The value can report to application 1360 the capabilities or state of a hardware component of device 1350, including those related to aspects such as input capabilities and state, output capabilities and state, processing capability, power state, storage capacity and state, and/or communications capability. In one or more implementations, API 1392 is implemented in part by firmware, microcode, or other low-level logic that executes in part on the hardware component.

In one or more implementations, API 1392 allows a developer of API-calling instructions 1380 (which can be a third-party developer) to leverage a feature provided by implementation instructions 1394. In such embodiments, there can be one or more set of API-calling instructions (e.g., including API-calling instructions 1380) that communicate with implementation instructions 1394. In one or more implementations, API 1392 allows multiple sets of API-calling instructions written in different programming languages to communicate with implementation instructions 1394 (e.g., API 1392 can include features for translating calls and returns between implementation instructions 1394 and API-calling instructions 1380) while API 1392 is implemented in terms of a specific programming language. In one or more implementations, API-calling instructions 1380 calls APIs from different providers such as a set of APIs from an OS provider, another set of APIs from a plug-in provider, and/or another set of APIs from another provider (e.g., the provider of a software library) or creator of the another set of APIs.

Examples of API 1392 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In one or more implementations the sensor API is an API for accessing data associated with a sensor of device 1350. For example, the sensor API can provide access to raw sensor data. For another example, the sensor API can provide data derived (and/or generated) from the raw sensor data. In one or more implementations, the sensor data includes temperature data, image data, video data, audio data, heart rate data, IMU (inertial measurement unit) data, lidar data, location data, GPS data, and/or camera data. In one or more implementations, the sensor includes one or more of an accelerometer, temperature sensor, infrared sensor, optical sensor, heartrate sensor, barometer, gyroscope, proximity sensor, temperature sensor and/or biometric sensor.

In one or more implementations, implementation instructions 1394 is a system (e.g., operating system, server system) software module (e.g., a collection of computer-readable instructions) that is constructed to perform an operation in response to receiving an API call via API 1392. In one or more implementations, implementation instructions 1394 is constructed to provide an API response (via API 1392) as a result of processing an API call. By way of example, implementation instructions 1394 and API-calling instructions 1380 can each be any one of an operating system, a library, a device driver, an API, an application program, or other module. It should be understood that implementation instructions 1394 and API-calling instructions 1380 can be the same or different type of software module from each other. In one or more implementations, implementation instructions 1394 is embodied at least in part in firmware, microcode, or other hardware logic.

In one or more implementations, implementation instructions 1394 returns a value through API 1392 in response to an API call from API-calling instructions 1380. While API 1392 defines the syntax and result of an API call (e.g., how to invoke the API call and what the API call does), API 1392 might not reveal how implementation instructions 1394 accomplishes the function specified by the API call. Various API calls are transferred via the one or more application programming interfaces between API-calling instructions 1380 and implementation instructions 1394. Transferring the API calls can include issuing, initiating, invoking, calling, receiving, returning, and/or responding to the function calls or messages. In other words, transferring can describe actions by either of API-calling instructions 1380 or implementation instructions 1394. In one or more implementations, a function call or other invocation of API 1392 sends and/or receives one or more parameters through a parameter list or other structure.

In one or more implementations, implementation instructions 1394 provides more than one API, each providing a different view of or with different aspects of functionality implemented by implementation instructions 1394. For example, one API of implementation instructions 1394 can provide a first set of functions and can be exposed to third-party developers, and another API of implementation instructions 1394 can be hidden (e.g., not exposed) and provide a subset of the first set of functions and also provide another set of functions, such as testing or debugging functions which are not in the first set of functions. In one or more implementations, implementation instructions 1394 calls one or more other components via an underlying API and thus be both an set of API calling instructions and a set of implementation instructions. It should be recognized that implementation instructions 1394 can include additional functions, methods, classes, data structures, and/or other features that are not specified through API 1392 and are not available to API calling instructions 1380. It should also be recognized that API calling instructions 1380 can be on the same system as implementation instructions 1394 or can be located remotely and access implementation instructions 1394 using API 1392 over a network. In one or more implementations, implementation instructions 1394, API 1392, and/or API-calling instructions 1380 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

In one or more implementations, process 200 (FIG. 2) is performed at a first computer system (as described herein) via a system process (e.g., an operating system process, a server system process) that is different from one or more applications executing and/or installed on the first computer system. In one or more other implementations, process 500 (FIG. 5) is performed at a first computer system (as described herein) via a system process (e.g., an operating system process, a server system process) that is different from one or more applications executing and/or installed on the first computer system.

In one or more implementations, process 200 (FIG. 2) is performed at a first computer system (as described herein) by an application that is different from a system process. In one or more implementations, the instructions of the application, when executed, control the first computer system to perform process 200 (FIG. 2) by calling an application programming interface (API) provided by the system process. In one or more implementations, the application performs at least a portion of process 200 without calling the API. In one or more other implementations, process 500 (FIG. 5) is performed at a first computer system (as described herein) by an application that is different from a system process. In one or more implementations, the instructions of the application, when executed, control the first computer system to perform process 500 (FIG. 5) by calling an application programming interface (API) provided by the system process. In one or more implementations, the application performs at least a portion of process 500 without calling the API.

In one or more implementations, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In one or more implementations, the application is an application that is pre-installed on the first computer system at purchase (e.g., a first party application). In one or more other implementations, the application is an application that is provided to the first computer system via an operating system update file (e.g., a first party application). In one or more other implementations, the application is an application that is provided via an application store. In some implementations, the application store is pre-installed on the first computer system at purchase (e.g., a first party application store) and allows download of one or more applications. In one or more implementations, the application store is a third-party application store (e.g., an application store that is provided by another device, downloaded via a network, and/or read from a storage device). In one or more implementations, the application is a third-party application (e.g., an app that is provided by an application store, downloaded via a network, and/or read from a storage device). In one or more implementations, the application controls the first computer system to perform process 500 (FIG. 5) by calling an application programming interface (API) provided by the system process using one or more parameters.

In one or more implementations, at least one API is a software module (e.g., a collection of computer-readable instructions) that provides an interface that allows a different set of instructions (e.g., API calling instructions) to access and use one or more functions, methods, procedures, data structures, classes, and/or other services provided by a set of implementation instructions of the system process. The API can define one or more parameters (e.g., adapter weights) that are passed between the API calling instructions and the implementation instructions.

As described above, in one or more implementations, the application controls the first computer system to perform process 500 (FIG. 5) by calling an application programming interface (API) provided by the system process using one or more parameters.

In one or more implementations, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a bluetooth API, an NFC API, a UWB API, a fitness API, a smart home API, contact transfer API, photos API, camera API, and/or image processing API. In one or more other implementations, exemplary APIs also include one or more of: a digital assistant API, a text assistant API, a generative runtime environment API, a text model inference API, a diffusion model inference API, a cloud LLM inference API, a proofreading API, a rewrite API, a smart reply API, and/or a third-party API.

In one or more implementations, the API 1392 defines a first API call that can be provided by API calling instructions 1380, in which the definition for the first API call specifies the following call parameters: proofread task API call parameters, rewrite task API call parameters, and/or smart reply task API call parameters, among others.

In one or more implementations, the API 1392 defines a first API call response that can be provided to the application by API calling instructions 1380, in which the first API call response indicates that an adapter is loaded with a base model by incorporating a set of mutable weight values of the adapter to the base model to perform a task associated with the application input.

In one or more implementations, the set of implementation instructions is a system software module (e.g., a collection of computer-readable instructions) that is constructed to perform an operation in response to receiving an API call via the API. In one or more implementations, the set of implementation instructions is constructed to provide an API response (via the API) as a result of processing an API call. In one or more implementations, the set of implementation instructions is included in the device (e.g., 1350) that runs the application. In one or more implementations, the set of implementation instructions is included in an electronic device that is separate from the device that runs the application.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
accessing, by a model manager of an electronic device, a model catalog comprising information associated with a plurality of machine learning models;
scheduling, by the model manager, execution of at least some of the plurality of machine learning models based on accessed information from the model catalog; and
executing, by the electronic device, the at least some of the plurality of machine learning models based at least in part on the scheduling.

2. The method of claim 1, wherein the scheduling is in response to a request for execution of at least one of the plurality of machine learning models by an application or operating system process.

3. The method of claim 1, wherein one or more of the plurality of machine learning models are executed on a server.

4. The method of claim 1, further comprising executing the model manager as a daemon process with sub-processes dedicated to inference tasks.

5. The method of claim 1, further comprising dynamically adjusting the scheduling of runtimes based on memory availability and processing load on an electronic device.

6. The method of claim 1, further comprising receiving an application programming interface call indicating a request to access at least one of the one or more machine learning models in the model catalog.

7. The method of claim 1, wherein the information indicates a base model and one or more associated adapters for each of the one or more machine learning models.

8. The method of claim 7, further comprising determining an estimation of memory characteristics associated with the base model and the one or more associated adapters.

9. The method of claim 7, wherein the information further indicates a relationship between the base model and the one or more associated adapters that enables a number of adapters to be stacked on the base model.

10. A system, comprising:
a model manager configured to schedule execution of one or more machine learning models on one or more electronic devices or servers; and
a model catalog configured to store information associated with the one or more machine learning models,
wherein the model manager accesses the model catalog to determine scheduling priorities based on the stored information.

11. The system of claim 10, wherein the model manager further comprises a daemon process for scheduling runtimes of the one or more machine learning models.

12. The system of claim 10, wherein the information indicates one or more memory characteristics for each of the one or more machine learning models.

13. The system of claim 10, wherein the information indicates a base model and one or more associated adapters for each of the one or more machine learning models.

14. The system of claim 13, wherein the model catalog is further configured to determine an estimation of memory characteristics associated with the base model and the one or more associated adapters.

15. The system of claim 13, wherein the information further indicates a relationship between the base model and the one or more associated adapters that enables a number of adapters to be stacked on the base model.

16. The system of claim 10, wherein the model manager is further configured to receive an application programming interface call indicating a request to access at least one of the one or more machine learning models in the model catalog.

17. The system of claim 10, wherein the model manager is further configured to adjust a memory allocation between sessions based on a state machine of each session.

18. A non-transitory machine-readable medium comprising code that, when executed by a processor, causes the processor to perform operations comprising:
accessing, by a model manager of an electronic device, a model catalog comprising information associated with a plurality of machine learning models;
scheduling, by a model manager, execution of at least some of the plurality of machine learning models based on accessed information from the model catalog; and
executing, by the electronic device, the at least some of the plurality of machine learning models based at least in part on the scheduling.

19. The non-transitory machine-readable medium of claim 18, wherein the operations further comprise receiving an application programming interface call indicating a request to access at least one of the one or more machine learning models in the model catalog.

20. The non-transitory machine-readable medium of claim 18, wherein the information indicates a base model and one or more associated adapters for each of the one or more machine learning models, and wherein the information further indicates a relationship between the base model and the one or more associated adapters that enables a number of adapters to be stacked on the base model.
